(19) United States
(12) Patent Application Publication
(10) Pub. No.: US 2026/0236546 A1
(43) Pub. Date: Aug. 13, 2026

(54) VEHICLE SYSTEM FOR RECOMMENDING SUGGESTED DESTINATIONS BASED ON CATEGORIZED DATA COLLECTED BY INTERNET OF THINGS DEVICES

(71) Applicant: GM Global Technology Operations LLC, Detroit, MI (US)

(72) Inventors: Eshan Dixit, Farmington Hills, MI (US); Paolo Giusto, Brentwood, CA (US); Prakash M. Peranandam, Rochester Hills, MI (US); Venkata Naga Siva Vikas Vemuri, Farmington Hills, MI (US)

(21) Appl. No.: 19/049,391

(22) Filed: Feb. 10, 2025

(51) Int. Cl. G06F 16/9537; G06F 16/215; G06F 16/9535

(52) U.S. Cl. CPC G06F 16/9537; G06F 16/215; G06F 16/9535

(57) ABSTRACT

A system for a vehicle includes data storage including categorized data captured by a plurality of Internet of things (IoT) devices according to individual categories, a user request data storage, an in-vehicle data storage, and one or more user profiles that are each associated with a unique occupant of the vehicle. The system also includes one or more controllers in electronic communication with the data storage. The one or more controllers execute instructions to clean and standardize, by one or more preprocessing algorithms the categorized data captured by the plurality of IoT devices. The one or more controllers recommend, by a large language model (LLM) and Retrieval-Augmented Generation (RAG) system, one or more suggested destinations for the vehicle based on the categorized data captured by one or more of the plurality of IoT devices.

### INTRODUCTION

The present disclosure relates to a vehicle system that recommends one or more suggested destinations based on categorized data collected by one or more Internet of Things (IoT) devices. Each suggested destination indicates a point of interest (POI) and one or more resources that are associated with the POI.

The Internet of Things (IoT) may refer to a network of smart devices that include network capability to connect and exchange data with other smart devices and systems over the Internet. Some examples of smart devices commonly found in an IoT network include, but are not limited to, smart appliances such as smart washing machines and smart refrigerators, smartphones, and virtual assistants.

The automotive IoT refers to the integration of network-capable devices such as cameras, sensors, and geotracking units in a vehicle that communicate with one another, the vehicle itself, and devices external to the vehicle such as, for example, other vehicles, mobile devices such as smartphones, and infrastructure. It is to be appreciated that automotive IoT technology may enable features such as, but not limited to, predictive maintenance, fleet management, vehicle-to-vehicle communication, autonomous driving, and in-vehicle infotainment. As a result, many customers have expressed a growing interest in IoT technologies implemented in vehicles.

Thus, while vehicles that include IoT technology achieve their intended purpose, there is a need in the art for additional features that enhance a customer's lifestyle and in-vehicle experiences.

### SUMMARY

According to several aspects, a system for a vehicle includes data storage including categorized data captured by a plurality of Internet of things (IoT) devices according to individual categories, a user request data storage, an in-vehicle data storage, and one or more user profiles that are each associated with a unique occupant of the vehicle. Each individual category represents a unique type of IoT device. The system also includes one or more controllers in electronic communication with the data storage. The one or more controllers execute instructions to execute one or more preprocessing algorithms to clean and standardize the categorized data captured by the plurality of IoT devices, the user request data storage, the in-vehicle data storage, and the one or more user profiles. The one or more controllers recommend, by a large language model (LLM) and Retrieval-Augmented Generation (RAG) system, one or more suggested destinations for the vehicle based on the categorized data captured by one or more of the plurality of IoT devices, the user request data storage, the in-vehicle data storage, and a user profile associated with the unique occupant of the vehicle, wherein each suggested destination includes a point of interest (POI) in combination with one or more resources that are associated with the POI. The one or more controllers instruct an autonomous driving system of the vehicle to determine and execute a route that the vehicle follows, where the route includes the one or more suggested destinations.

In another aspect, the one or more controllers execute instructions to dynamically prioritize the one or more suggested destinations based on a weighted function that considers one or more attributes associated with the one or more suggested destinations.

In yet another aspect, the one or more attributes include at least one of the following: a static attribute and a dynamic attribute.

In an aspect, the static attribute is one of the following: a distance between an origin and the POI associated with a suggested destination, urgency of a task associated with a particular suggested destination, and operating hours of the POI associated with the suggested destination.

In another aspect, the dynamic attribute is one of the following: habits of the unique occupant, the availability of resources available at the POI associated with a suggested destination, and feasibility.

In yet another aspect, the weighted function is expressed as:

$$f ( {t}_{i} ) = sum ( {\sum }_{j = 1}^{n} {K}_{{Attribute}_{j}} \cdot {Attribute}_{j} )$$

where f(tᵢ) represents the weighted function, K_{Attribute}_{ⱼ} represents the weight assigned to an attribute associated with the one or more suggested destinations, and Attributeⱼ represents the attribute.

In an aspect, plurality of IoT devices include one or more personal IoT devices associated with the unique occupant of the vehicle and one or more external IoT devices.

In another aspect, the individual categories for the type of IoT device include one or more of the following: a smart home device category, a smart wearable device category, an external IoT device category, a smart consumer device category, and a smartphone category.

In yet another aspect, the user request data storage stores data in the form of video, images, and text describing requests generated by the unique occupant of the vehicle, where the requests indicate an interaction between the unique occupant and the vehicle that reflect usage patterns of the vehicle.

In an aspect, the in-vehicle data storage stores data in the form of video, images, and text that are extracted from perception data captured by a plurality of perception sensors that are part of the vehicle, where the data describes general product availability.

In another aspect, each user profile stores data in the form of video, images, and text that are extracted from the plurality of IoT devices and the vehicle, where the data indicates interests and behavior associated with the unique occupant.

In yet another aspect, the LLM and RAG system includes one or more of the following: an agentic LLM, a general purpose LLM, a domain specific LLM, and a task-specific LLM.

In an aspect, the LLM and RAG system employs one or more of the following: hybrid RAG, corrective RAG, and self-RAG.

In another aspect, the one or more resources associated with the POI represents one or more of the following: goods that are required by one or more of the plurality of IoT devices, promotional items that are offered by the POI, and one or more documents that are required to complete a task at the POI.

In yet another aspect, a method includes providing data storage including categorized data captured by a plurality of IoT devices according to individual categories, a user request data storage, an in-vehicle data storage, and one or more user profiles that are each associated with a unique occupant of the vehicle, wherein each individual category represents a unique type of IoT device. The method includes executing, by one or more controllers in electronic communication with the data storage, one or more preprocessing algorithms to clean and standardize the categorized data captured by the plurality of IoT devices, the user request data storage, the in-vehicle data storage, and the one or more user profiles. The method further includes recommending, by a LLM and RAG system, one or more suggested destinations for the vehicle based on the categorized data captured by one or more of the plurality of IoT devices, the user request data storage, the in-vehicle data storage, and a user profile associated with the unique occupant of the vehicle, wherein each suggested destination includes a POI in combination with one or more resources that are associated with the POI, and instructing an autonomous driving system of the vehicle to determine and execute a route that the vehicle follows, where the route includes the one or more suggested destinations.

In yet another aspect, a system for a vehicle is disclosed, and includes data storage including categorized data captured by a plurality of IoT devices according to individual categories, a user request data storage, an in-vehicle data storage, and one or more user profiles that are each associated with a unique occupant of the vehicle, where each individual category represents a unique type of IoT device. The system also includes one or more controllers in electronic communication with the data storage. The one or more controllers execute instructions to execute one or more preprocessing algorithms to clean and standardize the categorized data captured by the plurality of IoT devices, the user request data storage, the in-vehicle data storage, and the one or more user profiles. The one or more controllers recommend, by a LLM and RAG system, one or more suggested destinations for the vehicle based on the categorized data captured by one or more of the plurality of IoT devices, the user request data storage, the in-vehicle data storage, and a user profile associated with the unique occupant of the vehicle, where each suggested destination includes a POI in combination with one or more resources that are associated with the POI. The one or more controllers dynamically prioritize the one or more suggested destinations based on a weighted function that considers one or more attributes associated with the one or more suggested destinations. The one or more attributes include at least one of the following: a static attribute and a dynamic attribute. The one or more controllers instruct an autonomous driving system of the vehicle to determine and execute a route that the vehicle follows, where the route includes the one or more suggested destinations.

In an aspect, the static attribute is one of the following: a distance between an origin and the POI associated with a suggested destination, urgency of a task associated with a particular suggested destination, and operating hours of the POI associated with the suggested destination.

In another aspect, the dynamic attribute is one of the following: habits of the unique occupant, the availability of resources available at the POI associated with a suggested destination, and feasibility.

In yet another aspect, the weighted function is expressed as:

$$f ( {t}_{i} ) = sum ( {\sum }_{j = 1}^{n} {K}_{{Attribute}_{j}} \cdot {Attribute}_{j} )$$

where f(tᵢ) represents the weighted function, K_{Attribute}_{ⱼ} represents the weight assigned to an attribute associated with the one or more suggested destinations, and Attributeⱼ represents the attribute.

In an aspect, the plurality of IoT devices include one or more personal IoT devices associated with the unique occupant of the vehicle and one or more external IoT devices.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a vehicle including the disclosed system having one or more controllers in electronic communication with one or more personal Internet of Things (IoT) devices associated with an occupant of the vehicle and one or more externally located IoT devices, according to an exemplary embodiment; and

FIG. 2 is a block diagram of the software architecture of the one or more controllers shown in FIG. 1, according to an exemplary embodiment.

### DETAILED DESCRIPTION

The following description is merely exemplary in nature and is not intended to limit the present disclosure, application, or uses.

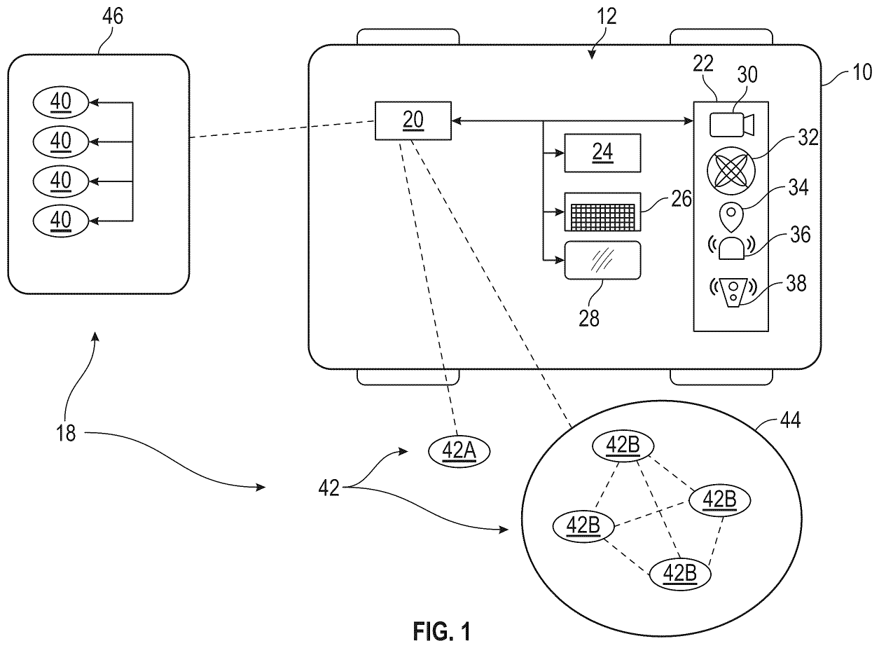

Referring to FIG. 1, a schematic diagram illustrating a vehicle 10 including the disclosed system 12 is shown. It is to be appreciated that the vehicle 10 may be any type of vehicle such as, but not limited to, a sedan, a truck, sport utility vehicle, van, or motor home. The system 12 includes one or more controllers 20 in electronic communication with a plurality of perception sensors 22, an autonomous driving system 24, a user input device 26, and a display 28. The one or more controllers 20 are also in wireless communication with a plurality of Internet of Things (IoT) devices 18. Specifically, in the exemplary embodiment as shown in FIG. 1 the plurality of IoT devices 18 include one or more personal IoT devices 40 that are associated with a unique occupant of the vehicle 10 and one or more external IoT devices 42 that are located in an environment that is external to the vehicle 10 that is not associated with an occupant of the vehicle 10. It is to be appreciated that while FIG. 1 illustrates the one or more controllers 20 as physically located on the vehicle 10, in another embodiment the one or more controllers 20 may be cloud-based instead.

The plurality of perception sensors 22 are each configured to collect perception data indicative of the environment surrounding the vehicle 10. In the non-limiting embodiment as shown in FIG. 1, the plurality of perception sensors 22 include one or more cameras 30, an inertial measurement unit (IMU) 32, a global positioning system (GPS) 34, radar 36, and LiDAR 38, however, it is to be appreciated that different or additional sensors may be used as well. The autonomous driving system 24 may be part of a fully autonomous driving system such as an automated driving system (ADS) or, alternatively, a semi-autonomous driving system such an advanced driver assistance system (ADAS).

The user input device 26 is any type of device for receiving user input generated by an occupant the vehicle 10 such as, for example, a touchscreen, a keypad, or a microphone. The display 28 shows graphics and images that are visible to the driver of the vehicle 10 and may be, for example, a liquid crystal display (LCD). In one non-limiting embodiment, the user input device 26 and the display 28 are part of an infotainment system of the vehicle 10

In one non-limiting embodiment, the personal IoT devices 40 are associated with one or more occupants of the vehicle 10. In the non-limiting embodiment as shown in FIG. 1, the personal IoT devices 40 are located at the occupant's residence 46, however, it is to be appreciated that the personal IoT devices 40 are not limited to a residence. For example, a personal IoT device 40 may be located at the occupant's place of business or worn by the occupant. The personal IoT devices 40 are smart devices that having wireless communication capabilities such as, but not limited to, a smartphone associated with the occupant of the vehicle 10, smart home devices such as smart thermostats, smart locks, virtual assistants, and smart doorbell cameras, smart wearable devices such as fitness trackers and electrocardiogram (ECG) monitors, and smart consumer devices such as smart refrigerators, smart coffeemakers, and smart washing machines.

The one or more external IoT devices 42 that are associated with the environment external to the vehicle 10 include one or more standalone external IoT devices 42A as well as a plurality of external IoT devices 42B that are associated with a smart ecosystem 44. Some examples of a standalone external IoT device 42A include, but are not limited to, smart parking meters, IoT beacons in found in establishments such as grocery stores, clothing stores, and malls, and smart traffic lights.

The plurality of external IoT devices 42B are part of smart ecosystem 44. A smart ecosystem 44 includes a network of connected smart devices (i.e., the plurality of external IoT devices 42B) that work with one another to exchange data to determine a common goal such as, for example, resource availability. In one non-limiting embodiment, the smart ecosystem 44 is a commercial establishment open to the public for carrying out commercial activities such as, but not limited to, a restaurant, a retail store, a financial institution, a supermarket, an automobile dealership or service shop, a storage locker for securing goods purchased online, a gym, a salon or barbershop, and medical establishments such as a dentist or physician's office or a hospital. In another embodiment, the smart ecosystem 44 may be a government agency such as the department of motor vehicles (DMV).

In one embodiment, the plurality of external IoT devices 42B communicate with one another to determine resource availability of the smart ecosystem 44. Merely by way of example, if the smart ecosystem 44 is a retail store, then the plurality of smart devices 44B may communicate with one another to determine the availability of a particular product sold at the retail store such as bread or eggs in a grocery store, or a specific brand of shoes at the mall. As another example, if the smart ecosystem 44 is the DMV, then the plurality of smart devices 44B may communicate with one another to determine the wait time before an individual is able to meet with a customer service representative.

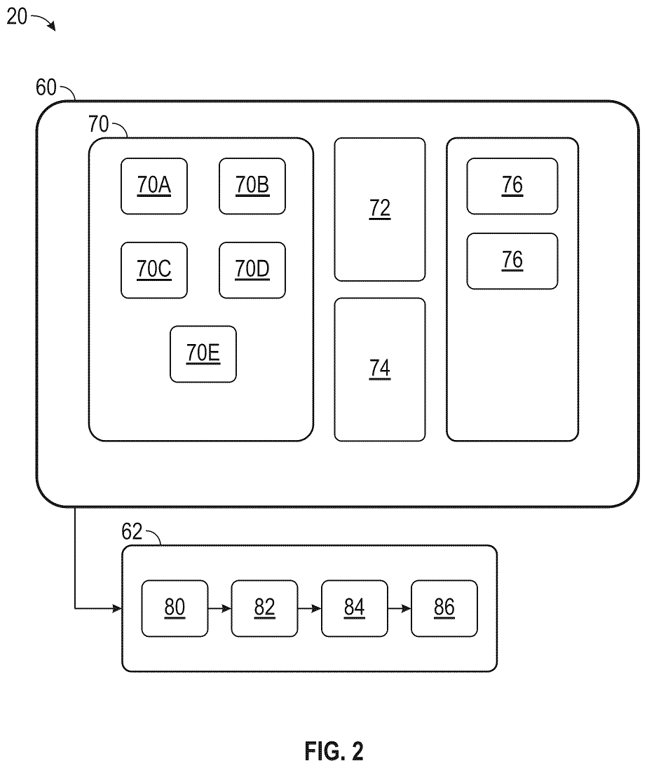

FIG. 2 is a block diagram of the software architecture of the one or more controllers 20 shown in FIG. 1. In the embodiment as shown in FIG. 2, the one or more controllers 20 are in electronic communication with data storage 60 that stores the data captured by the plurality of IoT devices 18 (FIG. 1). The one or more controllers 20 include a processing pipeline 62 that receives the data from the data storage 60. In the non-limiting embodiment as shown in FIG. 2, the data storage 60 is illustrated as being local to the vehicle 10, however, it is to be appreciated that the data storage 60 may be cloud-based instead.

As seen in FIG. 2, the data storage 60 includes an IoT device data storage category 70. The IoT device data storage category 70 stores categorized data captured by the plurality of IoT devices 18 (shown in FIG. 1) according to individual categories, where each individual category represents a unique class of IoT device. The unique class of IoT device is based on the usage of the particular IoT device 18 such as if the IoT device 18 is worn by an individual or is used in the home. In the non-limiting examples as illustrated in FIG. 2, five individual categories for the type of IoT device are classified as a smart home device category 70A, a smart wearable device category 70B, an external IoT device category 70C, smart consumer device category 70D, and a smartphone category 70E. Other examples of the unique class of IoT device include, but are not limited to, smart health IoT devices such as an ECG monitor and smart city IoT devices.

The categorized data collected by the IoT devices 40, 42 include data in the form of video, images, and text that describe usage of a particular IoT device. In one implementation, the usage of a particular IoT device may indicate goods that require replenishment. For example, the smart consumer device category 70D may store data associated with a smart refrigerator that indicates when grocery items such as bread, milk, and eggs require replenishment. The data associated with the smart refrigerator also indicates certain types of refrigerator containers for storing food may be required. In another example, a smart coffeemaker may indicate when additional coffee pods or single serving containers of instant coffee require replenishment. In yet another example, the smart wearable device category 70B may store health data associated with a fitness and activity tracker. In still another example, the external IoT device category 70C may store data indicating the availability of a particular product such as a specific soft drink brand that is available at the unique occupant's favorite grocery store.

The data storage 60 also includes a user request data storage 72, an in-vehicle data storage 74, and one or more user profiles 76. The user request data storage 72 stores data in the form of video, images, and text describing requests generated by a unique occupant of the vehicle 10 that are entered using either the user input device 26 (shown in FIG. 1) or, alternatively, by a smartphone associated with an occupant of the vehicle 10. The requests generated by the occupant of the vehicle 10 indicate an interaction between an occupant and the vehicle 10 that reflects usage patterns of the vehicle 10. Some examples of usage patterns of the vehicle 10 include, but are not limited to, a navigation request generated by the occupant or a request to download media files from the occupant.

The in-vehicle data storage 74 stores data in the form of video, images, and text that are extracted from the perception data indicative of the environment surrounding the vehicle 10 captured by the plurality of perception sensors 22 (FIG. 1), where the data describes general product availability. The products are available by a commercial establishment or government agency. Specifically, in one non-limiting embodiment the in-vehicle data storage 74 includes advertisement data extracted from objects such as, but not limited to, billboards and road signs located in the environment surrounding the vehicle 10, where the advertisement data may indicate that goods sold at a particular retail store are being offered at a reduced price. In another non-limiting embodiment, the in-vehicle data storage 74 includes data indicating product availability for a particular product. Some examples of products include, but are not limited to, an article of clothing such as a blouse or pants, a pair of sneakers originating from a specific brand, or camping gear such as tents or backpacks.

The one or more user profiles 76 are each associated with a unique occupant of the vehicle 10. Each user profile 76 stores data in the form of video, images, and text that are extracted from the IoT devices 40, 42 (FIG. 1) and the vehicle 10 indicating interests and behavior associated with the unique occupant. The interests and behavior associated with the unique occupant are determined based on usage patterns of the IoT devices 40, 42 as well as the vehicle 10. For example, data extracted from a smart refrigerator may indicate a brand of soft drink that is preferred by the occupant. As another example, the usage patterns of the vehicle 10 may indicate that the occupant always shops at a specific retail establishment on a particular day of the week. The interests and behavior associated with the unique occupant may also be determined based on email, texts, and calendar entries associated with the unique occupant that are collected from the user's smartphone or other computing device such as a tablet computer or laptop.

The interests associated with the unique occupant indicate a preference for specific commercial establishments or brand of goods. For example, the interests associated with the unique user may indicate a preference for a specific grocery store or restaurant, or a particular brand of soft drink or clothing. The behavior associated with the unique occupant indicates the habits of the unique occupant in relation to the vehicle 10. Specifically, the behavior associated with the unique occupant indicates specific establishments that the unique occupant visits as well as the time of day and/or the day of the week that the unique occupant frequents a particular establishment. Merely by way of example, the behavior associated with the unique occupant may indicate that the unique occupant visits a particular grocery store or warehouse club on Saturday afternoons.

Continuing to refer to FIG. 2, the processing pipeline 62 of the one or more controllers 20 shall now be described. In the non-limiting embodiment as shown in FIG. 2, the processing pipeline 62 includes a preprocessing module 80, a machine learning module 82, a prioritization module 84, and a customer retrieval module 86. The preprocessing module 80 of the processing pipeline 62 receives the categorized data captured by the plurality of IoT devices 18 (shown in FIG. 1), the user request data storage 72, the in-vehicle data storage 74, and the one or more user profiles 76 from the data storage 60 as input. The preprocessing module 80 then executes one or more preprocessing algorithms to clean and standardize the categorized data captured by the plurality of IoT devices 18 (shown in FIG. 1), the user request data storage 72, the in-vehicle data storage 74, and the one or more user profiles 76 from the data storage 60 prior to being processed by the machine learning module 82. Specifically, the one or more preprocessing algorithms identify and remove any missing, duplicate, corrupted, or irrelevant data to ensure that the data is in a condition for processing by the machine learning module 82.

Merely by way of example, some examples of preprocessing algorithms that may be used include, but are not limited to, data cleaning algorithms, text-based preprocessing algorithms, and image-based preprocessing algorithms. Some examples of data cleaning algorithms include, but are not limited to, the k-nearest neighbors (k-NN) algorithm and the z-score analysis. Some examples of text-based preprocessing algorithms include, but are not limited to, tokenization and word embedding. Some examples of image-based preprocessing algorithms include, but are not limited to, image resizing algorithms and normalization image processing algorithms.

The machine learning module 82 of the processing pipeline 62 receives the categorized data captured by the plurality of IoT devices 18 (shown in FIG. 1), the user request data storage 72, the in-vehicle data storage 74, and the one or more user profiles 76 from the data storage 60 from the preprocessing module 80. The machine learning module 82 includes a large language model (LLM) and Retrieval-Augmented Generation (RAG) system that recommends one or more suggested destinations for the vehicle 10 (shown in FIG. 1) based on the categorized data captured by one or more of the IoT devices 18 (shown in FIG. 1) that are stored according to the individual categories 70A-70E, the user request data storage 72, the in-vehicle data storage 74, and a user profile 76 associated with a unique occupant of the vehicle 10 stored in in the data storage 60.

It is to be appreciated that the LLM and RAG system may include any type of machine learning model that generates suggested items based on data in the form of video, images, and text. For example, the LLM and RAG system may include an agentic LLM, a general purpose LLM, a domain specific LLM, or a task-specific LLM. Some examples of domain specific LLMs include, but are not limited to, a bidirectional encoder representation from transformers for biomedical text mining (BioBERT) and bidirectional encoder representation from transformers for scientific text mining (SciBERT). Some examples of RAG techniques the LLM and RAG system employs include, but are not limited to, hybrid RAG, corrective RAG, and self-RAG. The LLM of the LLM and RAG system may recommend a plurality of suggested destinations for the vehicle 10 (FIG. 1) based on any of the individual categories 70A-70E, while the RAG technique may then narrow the plurality of suggested destinations by including only the most relevant suggested destinations.

Each suggested destination includes a point of interest (POI) in combination with one or more resources that are associated with the POI. The POI represents any location that the vehicle 10 may be driven to such as, for example, a commercial establishment open to the public for carrying out commercial activities such as a retail store, a government agency such as the DMV, and a storage locker maintained by an online retailer for storing goods purchased by a consumer. In one embodiment, the one or more resources associated with the POI represents goods that are required by one or more of the plurality of IoT devices 18 (shown in FIG. 1), where the goods are available at the suggested destination. As an example, the suggested destination may be a retail store that sells home furnishings, and the goods represent the specific types of containers for storing food that are required by a smart refrigerator. As another example, the suggested destination is a storage locker for storing goods that the unique occupant ordered online, and the goods represent the items that the unique occupant ordered online (e.g., a pair of shoes, etc.). In this example, the IoT device 18 is the smartphone associated with the unique occupant, where a notification is sent to the unique occupant's email account. In yet another example, the suggested destination may be a grocery store, and the goods are grocery items that are identified by the smart refrigerator.

In another embodiment, the one or more resources associated with the POI represent promotional items that are offered by the POI. The promotional items include coupons, vouchers, and applications that are downloaded to the smartphone associated with the unique occupant. For example, in one embodiment, if the POI is the mall, then the promotional item is a voucher that may be used to purchase clothing at a particular store at the mall. In another example, if the POI is a retail store, then the promotional item is an application associated with the retail store that is downloaded to the unique occupant's smartphone. In yet another example, the POI is a hospital and the promotional item is an application associated with the hospital that is downloaded to the unique occupant's smartphone.

In yet another embodiment, the one or more resources associated with the POI represent one or more documents that are required to complete a task at the POI. It is to be appreciated that the documents include physical documents such as a driver's license, passport, or any type of paper document as well as virtual documents. For example, if the POI is the DMV, then the one or more documents may include the driver's license or passport that requires renewal. As another example, if the POI is an office building associated with the workplace of the unique user, then the one or more documents include a presentation, notes, or other materials associated with a meeting that the unique occupant plans to attend.

Continuing to refer to FIG. 2, in one embodiment the prioritization module 84 of the processing pipeline 62 may then receive the one or more suggested destinations from the machine learning module 82 of the processing pipeline 62. It is to be appreciated that the prioritization module 84 is optional, and in some embodiments may be omitted from the processing pipeline 62. The prioritization module 84 dynamically prioritizes the one or more suggested destinations based on a weighted function that considers one or more attributes associated with the one or more suggested destinations, where the one or more attributes may be either a static attribute or a dynamic attribute.

A static attribute associated with the one or more suggested destinations does not change over the course of time, with some limited exceptions. Some examples of static attributes include, but are not limited to, a distance between an origin and the POI associated with the suggested destination and the operating hours of the POI associated with the suggested destination. As an example of operating hours, store hours do not typically change over the course of time, except some stores may expand or reduce their hours during a federal holiday or extenuating circumstances.

A dynamic attribute associated with the one or more suggested destinations has the potential to change over the course of time. Some examples of dynamic attributes include, but are not limited to, habits of the unique occupant, the availability of resources available at the POI associated with the suggested destination, and feasibility. Feasibility refers to the convenience associated with a suggested destination. As an example of feasibility, the convenience associated with a suggested destination may increase as the vehicle 10 travels closer to the particular suggested destination. For example, if the POI is a grocery store and the one or more resources that are associated with the POI includes goods such as eggs and milk, the availability of milk or eggs at the grocery store may fluctuate over the course of a day.

In one embodiment, the prioritization module creates a list of the suggested destinations in a dynamically descending order of priority, which is expressed in Equation 1 as:

$$Prioritization ( {t}_{A} , {t}_{B} , {t}_{C} … , {t}_{n} ) = Sort ( f ( {t}_{i} ) , reverse = True ) \qquad Equation 1$$

where (t_{A}, t_{B}, t_{C} . . . , tₙ) represents one of the suggested destinations and f(tᵢ) represents the weighted function.

In one embodiment, the weighted function is the summation of a product of a weight assigned to a particular attribute associated with the one or more suggested destinations and the particular attribute, where the summation includes each of the one or more suggested destinations. The weight is assigned to an attribute based on the importance of the attribute and may be determined based techniques such as, but not limited to rule-based methods, one or more machine learning techniques, or manually. For example, a task associated with a particular suggested destination to address a life-threatening issue would be assigned a higher weight when compared to a particular suggested destination to complete a routine errand. As another example, renewing a vehicle registration would be assigned a higher weight than buying groceries or going to the mall to purchase designer items currently being offered on special promotion. In one embodiment, the weighted function is expressed in Equation 2 as:

$$f ( {t}_{i} ) = sum ( {\sum }_{j = 1}^{n} {K}_{{Attribute}_{j}} \cdot {Attribute}_{j} ) \qquad Equation 2$$

where K_{Attribute}_{ⱼ} represents the weight assigned to an attribute associated with the one or more suggested destinations and Attributeⱼ represents the attribute.

The customer retrieval module 86 of the processing pipeline 62 may then receive the one or more suggested destinations from either the machine learning module 82 or prioritization module 84 of the processing pipeline 62. Referring to both FIGS. 1 and 2, the customer retrieval module 86 of the processing pipeline 62 may then instruct the display 28 to show the one or more suggested destinations to the unique occupant. In one embodiment, the customer retrieval module 86 instructs the display 28 to show a list of the suggested destinations in dynamically descending order of priority. In embodiments, the unique occupant may modify the list the suggested destinations to either re-prioritize one of the entries, delete one of the entries, or introduce an additional entry to the list of suggested destinations by entering input into the user input device 26 (FIG. 1).

The customer retrieval module 86 may also transmit the list of the suggested destinations in dynamically descending order of priority to the autonomous driving system 24. In one embodiment, the customer retrieval module 86 may instruct the autonomous driving system 24 to determine and execute a route that the vehicle 10 follows, where the route guides the vehicle 10 to the suggested destinations. In an embodiment where the suggested destinations are listed in a dynamically descending order of priority, the route may be calculated to prioritize the higher priority suggestions. For example, the route is determined so that POIs associated with higher priority suggested destinations are visited first by the vehicle 10. It is also to be appreciated that the route may be dynamically updated to reflect any changes in priority of a particular suggested destination. For example, if the priority associated with one of the suggested destinations is now lower than the priority associated with another suggested destination that is part of the list, the route may be updated so that the higher priority suggested destination is visited first. In embodiments, the autonomous driving system 24 instructs the vehicle 10 to drive to the POIs associated with the suggested destinations.

Referring generally to the figures, the disclosed vehicle system provides various technical effects and benefits. Specifically, the disclosed system recommends one or more suggested destinations for the vehicle based on the categorized data captured by one or more of the IoT devices, the user request data storage, the in-vehicle data storage, and a user profile associated with a unique occupant of the vehicle stored in in the data storage, which may enhance an occupant's lifestyle and in-vehicle experiences.

The controllers may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the controllers may be microprocessor-based such as a computer having at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A system for a vehicle, the system comprising:
data storage including categorized data captured by a plurality of Internet of things (IoT) devices according to individual categories, a user request data storage, an in-vehicle data storage, and one or more user profiles that are each associated with a unique occupant of the vehicle, wherein each individual category represents a unique class of IoT device, and wherein the individual categories for the unique class of IoT device include the following: a smart home device category, a smart wearable device category, an external IoT device category, a smart consumer device category, and a smartphone category; and
one or more controllers in electronic communication with the data storage, wherein the one or more controllers execute instructions to:
execute one or more preprocessing algorithms to clean and standardize the categorized data captured by the plurality of IoT devices, the user request data storage, the in-vehicle data storage, and the one or more user profiles;
recommend, by a large language model (LLM) and Retrieval-Augmented Generation (RAG) system, one or more suggested destinations for the vehicle based on the categorized data captured by one or more of the plurality of IoT devices, the user request data storage, the in-vehicle data storage, and a user profile associated with the unique occupant of the vehicle, wherein each suggested destination includes a point of interest (POI) in combination with one or more resources that are associated with the POI; and
instruct an autonomous driving system of the vehicle to determine and execute a route that the vehicle follows, wherein the route includes the one or more suggested destinations.

2. The system of claim 1, wherein the one or more controllers execute instructions to:
dynamically prioritize the one or more suggested destinations based on a weighted function that considers one or more attributes associated with the one or more suggested destinations.

3. The system of claim 2, wherein the one or more attributes include at least one of the following: a static attribute and a dynamic attribute.

4. The system of claim 3, wherein the static attribute is one of the following: a distance between an origin and the POI associated with a suggested destination, urgency of a task associated with a particular suggested destination, and operating hours of the POI associated with the suggested destination.

5. The system of claim 3, wherein the dynamic attribute is one of the following: habits of the unique occupant, the availability of resources available at the POI associated with a suggested destination, and feasibility.

6. The system of claim 2, wherein the weighted function is expressed as:
$$f ( {t}_{i} ) = sum ( {\sum }_{j = 1}^{n} \text{?} {K}_{{Attribute}_{j}} \cdot {Attribute}_{j} ) \text{?}$$
wherein f(tᵢ) represents the weighted function, K_{Attribute}_{ⱼ} represents the weight assigned to an attribute associated with the one or more suggested destinations, and Attributeⱼ represents the attribute.

7. The system of claim 1, wherein plurality of IoT devices include one or more personal IoT devices associated with the unique occupant of the vehicle and one or more external IoT devices.

8. (canceled)

9. The system of claim 1, wherein the user request data storage stores data in the form of video, images, and text describing requests generated by the unique occupant of the vehicle, wherein the requests indicate an interaction between the unique occupant and the vehicle that reflect usage patterns of the vehicle.

10. The system of claim 1, wherein the in-vehicle data storage stores data in the form of video, images, and text that are extracted from perception data captured by a plurality of perception sensors that are part of the vehicle, wherein the data describes general product availability.

11. The system of claim 1, wherein each user profile stores data in the form of video, images, and text that are extracted from the plurality of IoT devices and the vehicle, wherein the data indicates interests and behavior associated with the unique occupant.

12. The system of claim 1, wherein the LLM and RAG system includes one or more of the following: an agentic LLM, a general purpose LLM, a domain specific LLM, and a task-specific LLM.

13. The system of claim 1, wherein the LLM and RAG system employs one or more of the following: hybrid RAG, corrective RAG, and self-RAG.

14. The system of claim 1, wherein the one or more resources associated with the POI represents one or more of the following: goods that are required by one or more of the plurality of IoT devices, promotional items that are offered by the POI, and one or more documents that are required to complete a task at the POI.

15. A method, comprising:
providing data storage including categorized data captured by a plurality of IT devices according to individual categories, a user request data storage, an in-vehicle data storage, and one or more user profiles that are each associated with a unique occupant of a vehicle, wherein each individual category represents a unique class of IoT device, and wherein the individual categories for the unique class of IoT device include the following: a smart home device category, a smart wearable device category, an external IoT device category, a smart consumer device category, and a smartphone category;
executing, by one or more controllers in electronic communication with the data storage, one or more preprocessing algorithms to clean and standardize the categorized data captured by the plurality of IoT devices, the user request data storage, the in-vehicle data storage, and the one or more user profiles;
recommending, by a LLM and RAG system, one or more suggested destinations for the vehicle based on the categorized data captured by one or more of the plurality of IoT devices, the user request data storage, the in-vehicle data storage, and a user profile associated with the unique occupant of the vehicle, wherein each suggested destination includes a POI in combination with one or more resources that are associated with the POI; and
instructing an autonomous driving system of the vehicle to determine and execute a route that the vehicle follows, wherein the route includes the one or more suggested destinations.

16. A system for a vehicle, the system comprising:
data storage including categorized data captured by a plurality of IoT devices according to individual categories, a user request data storage, an in-vehicle data storage, and one or more user profiles that are each associated with a unique occupant of the vehicle, wherein each individual category represents a unique class of IoT device, and wherein the individual categories for the unique class of IoT device include the following: a smart home device category, a smart wearable device category, an external IoT device category, a smart consumer device category, and a smartphone category; and
one or more controllers in electronic communication with the data storage, wherein the one or more controllers execute instructions to:
execute one or more preprocessing algorithms to clean and standardize the categorized data captured by the plurality of IoT devices, the user request data storage, the in-vehicle data storage, and the one or more user profiles;
recommend, by a LLM and RAG system, one or more suggested destinations for the vehicle based on the categorized data captured by one or more of the plurality of IoT devices, the user request data storage, the in-vehicle data storage, and a user profile associated with the unique occupant of the vehicle, wherein each suggested destination includes a POI in combination with one or more resources that are associated with the POI;
dynamically prioritize the one or more suggested destinations based on a weighted function that considers one or more attributes associated with the one or more suggested destinations, wherein the one or more attributes include at least one of the following: a static attribute and a dynamic attribute; and
instruct an autonomous driving system of the vehicle to determine and execute a route that the vehicle follows, wherein the route includes the one or more suggested destinations.

17. The system of claim 16, wherein the static attribute is one of the following: a distance between an origin and the POI associated with a suggested destination, urgency of a task associated with a particular suggested destination, and operating hours of the POI associated with the suggested destination.

18. The system of claim 16, wherein the dynamic attribute is one of the following: habits of the unique occupant, the availability of resources available at the POI associated with a suggested destination, and feasibility.

19. The system of claim 16, wherein the weighted function is expressed as:
$$f ( {t}_{i} ) = sum ( {\sum }_{j = 1}^{n} \text{?} {K}_{{Attribute}_{j}} \cdot {Attribute}_{j} ) \text{?}$$
wherein f(tᵢ) represents the weighted function, K_{Attribute}_{ⱼ} represents the weight assigned to an attribute associated with the one or more suggested destinations, and Attributeⱼ represents the attribute.

20. The system of claim 16, wherein plurality of IoT devices include one or more personal IoT devices associated with the unique occupant of the vehicle and one or more external IoT devices.

21. The system of claim 1, wherein the unique class of IoT device is based on the usage of a particular IoT device, and wherein the usage indicates one of the following: the IoT device is worn by an individual and is used in the home.
